(19) United States
(12) Patent Application Publication
(10) Pub. No.: US 2026/0354599 A1
(43) Pub. Date: Nov. 12, 2026

(54) THERMAL INSULATION STRUCTURE FOR INFLATABLE MATTRESS

(71) Applicant: FENG YI OUTDOOR LEISURE EQUIPMENT ENTERPRISE CO., LTD, TAICHUNG CITY (TW)

(72) Inventor: PING TING LIN, TAICHUNG CITY (TW)

(21) Appl. No.: 19/201,332

(22) Filed: May 7, 2025

(51) Int. Cl. A47C 27/00; A47C 27/08; F16L 59/02

(52) U.S. Cl. CPC A47C 27/002; A47C 27/081; A47C 27/087; F16L 59/029

(57) ABSTRACT

A thermal insulation structure for an inflatable mattress is provided, particularly one configured to enhance thermal retention while providing improved strength and toughness. The structure includes a thermal insulation material disposed within each air channel of the inflatable mattress. The thermal insulation material includes a polyethylene terephthalate (PET) film laminated with a synthetic cotton on its upper surface and coated with an electroplated aluminum film on its lower surface. The aluminum film is oriented to face the interior of the air channel, enhancing thermal radiation reflection. The PET film provides mechanical strength and interlayer bonding with the synthetic cotton, improving both insulation performance and structural integrity within the inflatable mattress.

### FIELD OF INVENTION

The present invention relates to a thermal insulation structure for an inflatable mattress, and more particularly to an inflatable mattress structure configured to provide enhanced thermal retention with increased structural strength and toughness.

### BACKGROUND OF THE INVENTION

Conventional inflatable mattresses are widely used in outdoor environments, such as mountaineering and camping, and are designed to be deflatable and inflatable to facilitate portability and user convenience. As shown in FIGS. 1 and 2, a conventional inflatable mattress 10 comprises an upper layer 11 and a lower layer 12, each internally coated with a thermoplastic polyurethane (TPU) film that is adhesive and impermeable to air. The upper and lower layers 11 and 12 are sealed along their peripheries by a thermal fusion. A plurality of internal baffles 13, formed from TPU or other polymeric materials, is thermally bonded between the upper layer 11 and the lower layer 12 with two ends of the internal baffles 13. The internal baffles 13 are arranged in parallel, thereby defining a plurality of parallel and interconnected air channels 14 between the upper and lower layers 11 and 12. An air valve 15 is provided on one side of the inflatable mattress 10 to facilitate inflation. When air is introduced via the air valve 15, it flows through the air channels 14, inflating the entire inflatable mattress 10 and forming an elastic support surface suitable for a user to lie on during outdoor activities. To enhance thermal insulation, it is common to fill the air channels 14 with insulating materials such as down or cotton batting. While these lightweight materials provide some insulating effect, they are prone to displacement due to internal air circulation. As a result, the insulating materials become unevenly distributed within the inflatable mattress 10, thereby diminishing thermal performance and hindering efficient inflation.

### SUMMARY OF THE INVENTION

The primary objective of the present invention is to provide an improved thermal insulation structure for an inflatable mattress, in which a thermal insulation material is disposed within each of the air channels. The thermal insulation material comprises electroplated aluminum films arranged facing the interior of the air channels in opposing orientations. This configuration generates a radiant refraction effect between the reflective surfaces of the electroplated aluminum films, thereby enhancing the reflection of thermal radiation and significantly improving heat retention performance. Additionally, the thermal insulation material is formed from a polyethylene terephthalate (PET) film, which exhibits excellent mechanical strength and toughness. The PET film is also laminated with a synthetic cotton to form a composite insulation structure with reliable interlayer bonding and high durability, thereby providing both improved thermal insulation and enhanced structural integrity within the inflatable mattress.

To achieve the foregoing objective, the inflatable mattress structure comprises an upper layer and a lower layer, each internally coated with an adhesive and airtight thermoplastic polyurethane (TPU) film and sealed along their peripheral edges by a thermal fusion. A plurality of internal baffles is thermally bonded between the upper and lower layers and arranged in parallel, thereby defining a series of parallel and interconnected air channels. A thermal insulation material is disposed within each of the air channels. The thermal insulation material comprises the polyethylene terephthalate (PET) film laminated with the synthetic cotton layer on its upper surface and coated on its lower surface with the electroplated aluminum film, applied via an electroplating process.

### BRIEF DESCRIPTION OF THE DRAWINGS

FIG. 1 is a perspective view of a conventional inflatable mattress;

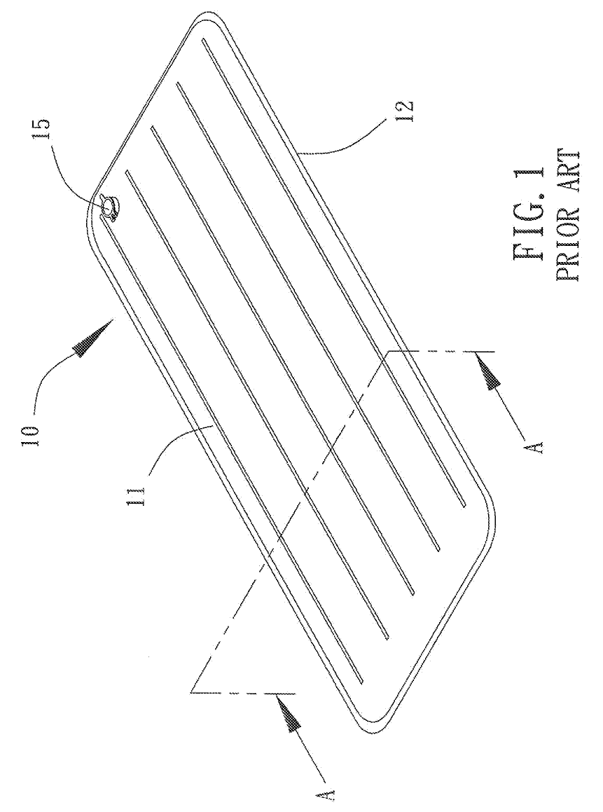

FIG. 2 is a cross-sectional view along line A-A of FIG. 1;

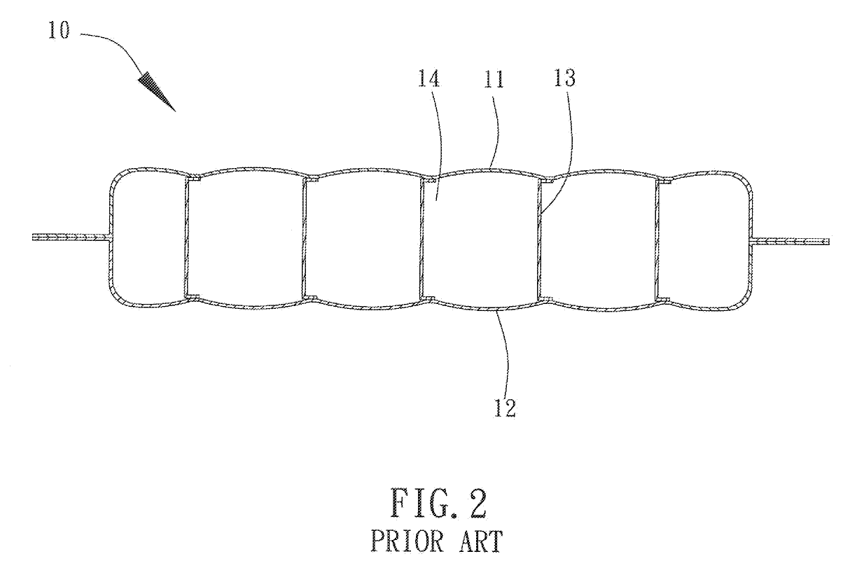

FIG. 3 is a partial exploded perspective view of the present disclosure;

FIG. 4 is a cross-sectional view along line B-B of FIG. 3;

FIG. 5 is a perspective view of the thermal insulation material;

FIG. 6 is an exploded view of the thermal insulation material; and

FIG. 7 is an alternate perspective view of the thermal insulation material.

### DETAILED DESCRIPTION OF THE PREFERRED EMBODIMENTS

The structure, features, and functional advantages of the present disclosure will be described in greater detail below with reference to the accompanying drawings and preferred embodiments.

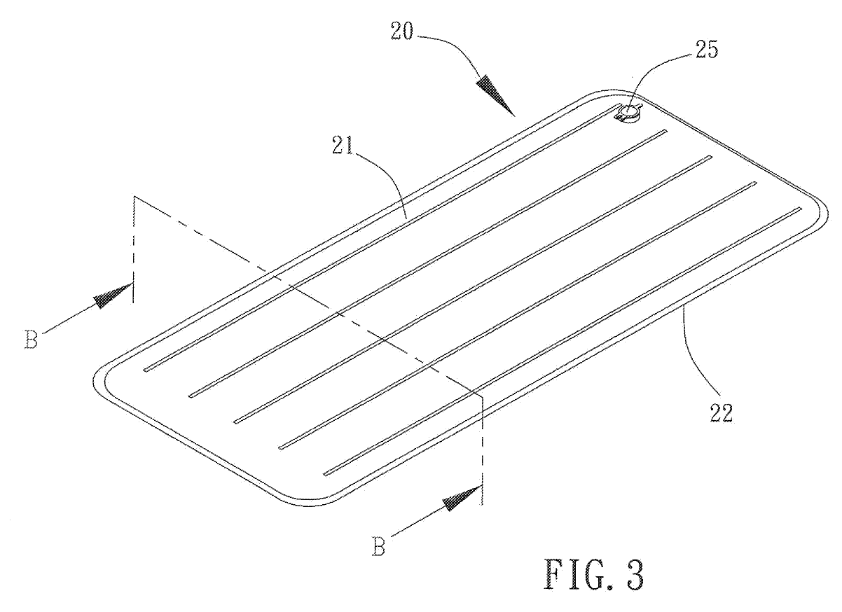

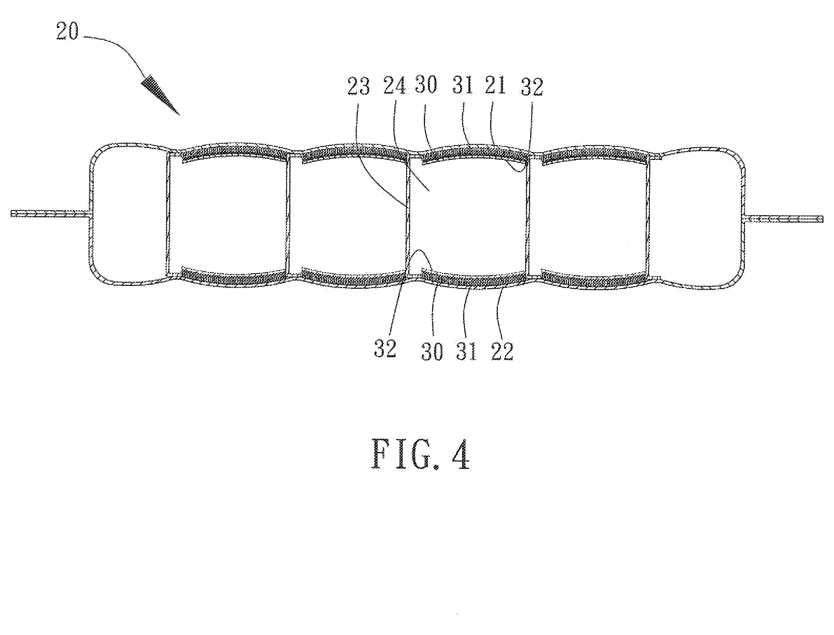

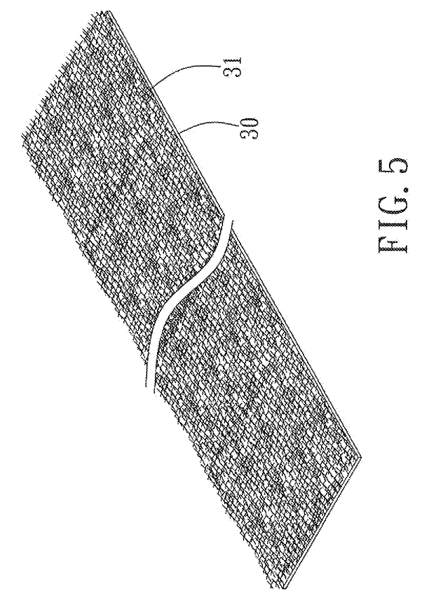

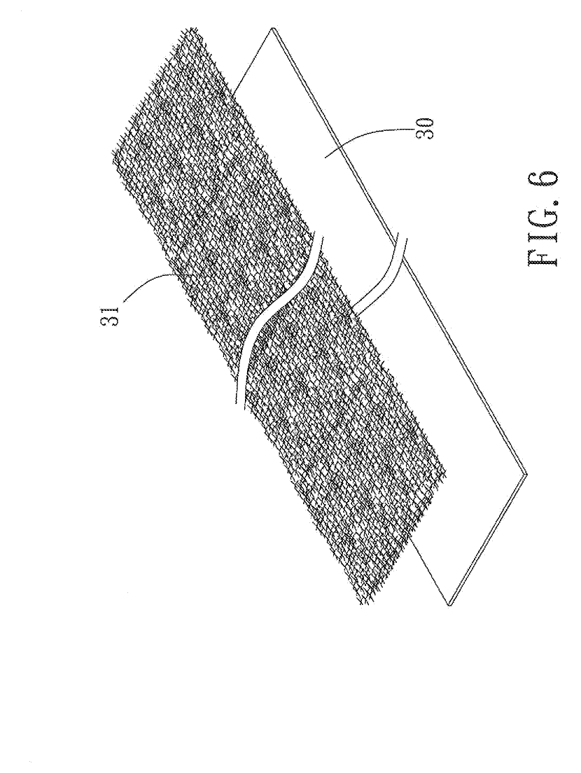

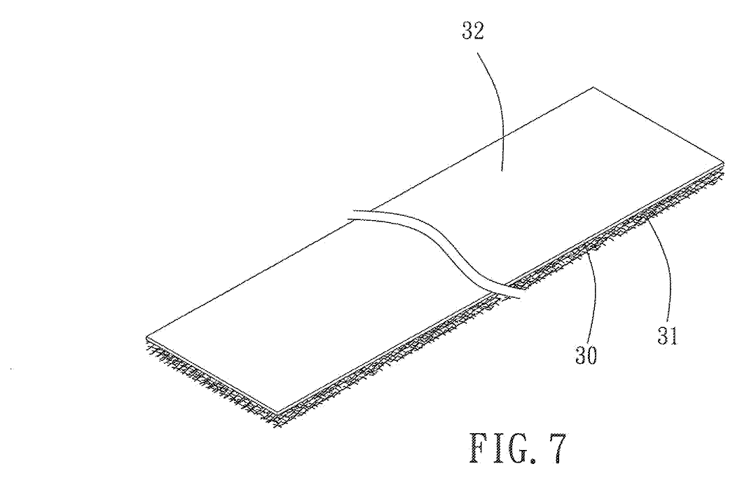

As illustrated in FIGS. 3-7, the present disclosure primarily comprises an inflatable mattress 20 and a thermal insulation material 30.

The inflatable mattress 20 comprises an upper layer 21 and a lower layer 22, each internally coated with an adhesive and airtight thermoplastic polyurethane (TPU) film and sealed together along their peripheral edges. A plurality of internal baffles 23, made of TPU or other polymeric materials, is thermally bonded between the upper and lower layers 21 and 22 using a fusion process. The internal baffles 23 are arranged in parallel and bonded at their respective upper and lower ends to the upper and lower layers 21, 22, thereby defining a series of parallel and interconnected air channels 24.

The thermal insulation material 30 is disposed within the air channels 24 of the inflatable mattress 20. The thermal insulation material 30 comprises a polyethylene terephthalate (PET) film, with its upper surface laminated with a synthetic cotton 31 and its lower surface coated with an electroplated aluminum film 32.

When external air is introduced into the inflatable mattress 20 via an air valve 25, it flows through the air channels 24 to inflate the entire mattress, thereby forming an inflatable support layer. The thermal insulation material 30 is positioned above and below within each of the air channels 24 and is oriented so that its electroplated aluminum layer 32 faces the interior of each air channel 24. This opposing configuration of reflective surfaces creates a radiant refraction effect between the electroplated aluminum layers 32, thereby enhancing thermal radiation reflection within the air channels 24 and significantly improving the insulation performance. In addition, because the thermal insulation material 30 is formed from the polyethylene terephthalate (PET) film, its upper surface provides reliable interlayer adhesion for the synthetic cotton layer 31, thereby ensuring consistent insulation effectiveness of the inflatable mattress 20. Furthermore, the inherent mechanical strength and toughness of the PET film enables the thermal insulation material 30 to withstand the stresses of repeated inflation, deflation, and folding during storage, thereby contributing to the long-term durability of the inflatable mattress 20.

The foregoing description illustrates the preferred embodiments of the present disclosure. However, various modifications and equivalent implementations may be made by those skilled in the art without departing from the spirit and scope of the disclosure, which is defined solely by the appended claims.

What is claimed is:

1. A thermal insulation structure for an inflatable mattress, comprising:
an inflatable mattress comprising an upper layer and a lower layer, each internally coated with an adhesive and airtight thermoplastic polyurethane (TPU) film and sealed together along their peripheral edges, the upper and lower layers being interconnected by a plurality of internal baffles thermally bonded therebetween by a fusion process, the internal baffles being arranged in parallel and bonded at their respective upper and lower ends to the upper and lower layers to define a series of parallel and interconnected air channels; and
a thermal insulation material disposed within each of the air channels, the thermal insulation material comprising a polyethylene terephthalate (PET) film laminated with a synthetic cotton on an upper surface thereof and coated with an electroplated aluminum film on a lower surface thereof.

2. The structure according to claim 1, wherein the electroplated aluminum film is applied by an electroplating process.
